(19) United States
(12) Patent Application Publication
(10) Pub. No.: US 2007/0111014 A1
(43) Pub. Date: May 17, 2007

(54) Silicone based dielectric coatings and films for photovoltaic applications

(75) Inventors: Dimitris Katsoulis, Midland, MI (US); Michitaka Suto, Kanagawa (JP)

Correspondence Address: GIFFORD, KRASS, SPRINKLE,ANDERSON & CITKOWSKI, P.C, PO BOX 7021, TROY, MI, 48007-7021, US

(73) Assignee: DOW CORNING CORPORATION, Midland, MI (US)

(21) Appl. No.: 10/566,788

(22) PCT Filed: Jun. 18, 2004
(86) PCT No.: PCT/US04/19609

§ 371 Date: Jun. 1, 2006

Related U.S. Application Data
(60) Provisional application No. 60/491,883, filed on Aug. 1, 2003.

(51) Int. Cl. B32B 9/04; C08G 77/04

(52) U.S. Cl. 428/447; 106/287.13; 106/287.12; 528/32; 528/43

(57) ABSTRACT

A dielectric coating for use on a conductive substrate including a silicone composition of the formula: [RₓSiO(₄₋ₓ)_{/2}]ₙ wherein x=1-4 and wherein R comprises of methyl, or phenyl, or hydrido, or hydroxyl or alkoxy or combination of them (when 1<x<4). R can also comprise other monovalent radicals independently selected from alkyl or aryl groups, arylether, alkylether, alylamide, arylamide, alkylamino and arylamino radicals. The dielectric coating has a network structure. A photovoltaic substrate is also disclosed and includes a conductive material having a dielectric coating disposed on a surface of the conductive material.

### FIELD OF THE INVENTION

The invention relates to a silicone based dielectric coating and planarizing coating and with more particularity the invention relates to a silicone based dielectric coating for photovoltaic applications, and thin film transistor (TFT) applications, including organic thin film transistor (OTFT) applications, and light emitting diode (LED) applications including organic light emitting diode (OLED) applications.

### BACKGROUND OF THE INVENTION

Semiconductor devices often have one or more arrays of patterned interconnect levels that serve to electrically couple the individual circuit elements forming an integrated circuit (IC). The interconnect levels are typically separated by an insulating or dielectric coating. Previously, a silicon oxide coating formed using chemical vapor deposition (CVD) or plasma enhanced techniques (PECVD) was the most commonly used material for such dielectric coatings. However, as the size of circuit elements and the spaces between such elements decreases, the relatively high dielectric constant of such silicon oxide coatings is inadequate to provide adequate electrical insulation. Specifically, semiconductor devices for use in the field of photovoltaics generally relate to the development of multi-layer materials that convert sunlight directly into DC electrical power. Photovoltaic devices or solar cells are typically configured as a cooperating sandwich of p- and n-type semiconductors, wherein the n-type semiconductor material exhibits an excess of electrons, and the p-type semiconductor material exhibits an excess of holes. Such a structure, when appropriately located electrical contacts are included, forms a working photovoltaic cell. Sunlight incident on photovoltaic cells is absorbed in the p-type semiconductor creating electron/hole pairs. By way of a natural internal electric field created by sandwiching p- and n-type semiconductors, electrons created in the p-type material flow to the n-type material where they are collected, resulting in a DC current flow between the opposite sides of the structure when the same is employed within an appropriate, closed electrical circuit.

Thin film photovoltaics have seen increased interest for use in commercial and consumer applications. However, widespread use remains limited due to the high cost and labor intensive manufacturing processes currently utilized.

Thin film based photovoltaics, namely amorphous silicon, cadmium telluride, and copper indium diselenide, offer improved cost by employing deposition techniques widely used in the thin film industry for protective, decorative, and functional coatings. Copper indium gallium diselenide (CIGS) has demonstrated a potential for producing high performance, low cost thin film photovoltaic products.

However, the CIGS process has a temperature generally in the range of 550 degrees centigrade (with resident time of at least an hour) limiting the type of substrate that may be utilized. Commonly used substrates such as polyimide, glass and stainless steel have limitations in terms of the use in a CIGS process. The polyimide substrate cannot withstand the CIGS process temperature and the glass substrate while withstanding the high temperature requires large manufacturing facilities and complex process controls to prevent the fracture of the glass substrate. Stainless steel provides a high temperature resistant substrate that has a low cost, but does not have good dielectric properties to allow monolithic integration of a solar cell produced using laser scribing. As a result, a stainless steel substrate limits the use of a continuous manufacturing process. There is therefore a need in the art for a substrate that has a high temperature resistance combined with good dielectric properties to provide for a roll to roll processing and also allows monolithic integration of the substrate.

An additional requirement for a substrate is the surface roughness of the substrate. A desired surface roughness should be below 50 nm. This is very difficult to achieve with polishing techniques. There is therefore, the additional need for a substrate with very smooth surface as well.

Applications where flexible robust substrates such as metal foils are needed are being pursued beyond the photovoltaic market into the flexible electronics markets for large area electronics, as well as small area electronics. These applications include Liquid Crystal Displays, (LCDs), electronic paper product concepts (e-paper), LEDs, & OLEDs, structures, etc. Traditionally, these electronic devices were built on glass substrates, but because of the trend towards flexible electronics, robust foil substrates are being sought. These devices require a dielectric planarizing support. Glass substrates exhibit these properties, but metallic foils such as stainless steel or aluminum are not insulating and require extensive polishing to achieve smooth surfaces. Using current polishing techniques, the surface roughness is often too high to achieve good interface with the subsequently deposited layers. Some application may require surface roughness as low as 1 nm (RMS), which cannot be attained by chemical or mechanical polishing of the substrate. Such applications require the use of a dielectric, planarizing coating. The dielectric coating should be stable at high temperatures as most of the subsequent deposition layers (conductive electrodes or compound semiconductors) require high temperatures for crystal growth. Annealing is a common process that is used after deposition with temperature requirements and residence times vary with the device. For example, polycrystalline silicon—based devices such as TFT's require temperatures up to 450° C. while amorphous silicon—based devices usually require temperatures <300° C.

There is therefore, a need for high temperature stable, planarizing flexible dielectric substrates amenable for use in a roll to roll process.

### SUMMARY OF THE INVENTION

A dielectric coating for use on a conductive substrate including a silicone composition of the formula:
[RₓSiO_{(4-x)/2}]ₙ
wherein x=1-4 and wherein R comprises_of methyl, or phenyl, or hydrido, or hydroxyl or alkoxy or combination of them (when 1<x<4). R can also comprise other monovalent radicals independently selected from alkyl or aryl groups, arylether, alkylether, alylamide, arylamide, alkylamino and arylamino radicals The dielectric coating has a network structure.

A photovoltaic substrate is also disclosed and includes a conductive material having a dielectric coating disposed on a surface of the conductive material. The dielectric material is a silicone composition of the formula:
[RₓSiO_{(4-x)/2}]ₙ
wherein x=1-4 and wherein R comprises_of methyl, or phenyl, or hydrido, or hydroxyl or alkoxy or combination of them (when 1<x<4). R can also comprise of other monovalent radicals independently selected from alkyl or aryl groups, arylether, alkylether, alylaamide, arylamide, alkylamino and arylamino radicals. The dielectric coating has a network structure.

### DETAILED DESCRIPTION OF THE PREFERRED EMBODIMENTS

This invention relates to a dielectric coating for use on a conductive substrate, as well as a substrate material having the coating applied to one surface. The dielectric coating comprises a silicone composition of the formula:: [RSiO_{(4-x)/2}]ₙ wherein x=1-4 and wherein R comprises of methyl, or phenyl, or hydrido, or hydroxyl or alkoxy or combination of them (when 1<x<4). R can also comprise of other monovalent radicals independently selected from alkyl or aryl groups, alylamide, arylamide, alkylamino and arylamino radicals. The dielectric coating preferably has a network structure.

In one embodiment of the present invention, the dielectric coating comprises a silsesquioxane compound of the formula: [RSiO_{3/2}]ₙ wherein R comprises of methyl, or phenyl, or hydrido, or hydroxyl or alkoxy or combination of them (when 1<x<4). R can also comprise of other monovalent radicals independently selected from alkyl or aryl groups, alylamide, arylamide, alkylamino and arylamino radicals. Examples of silsesquioxane polymers are [HSiO_{3/2}]ₙ, [MeSiO_{3/2}]ₙ, [HSiO_{3/2}]ₙ[MeSiO_{3/2}]ₘ, where m+n=1; [PhSiO_{3/2}]ₙ[MeSiO_{3/2}]ₘ, m+n=1; [PhSiO_{3/2}]ₙ[MeSiO_{3/2}]ₘ[PhMeSiO]ₚ, m+n+p=1.

In one aspect of the present invention, the silsesquioxane polymer contains silanol units [RSi(OH)ₓO_{y}], where x+y=3, and which can be siliylated with appropriate organisiloxanes to produce corresponding silylated polysilsesquioxanes. The starting silsesquioxanes usually have average number molecular weight in the range of 380 to 12000 and most frequently in the range of 4000, although there is no limitation on how high the molecular weight of the polymer should be to function as an effective dielectric coating other than the ease of its processability during the coating application. For example a polysilsesquioxane resin with empirical formula: [PhSiO_{3/2}]ₙ[MeSiO_{3/2}]ₘ[PhMeSiO]ₚ, m+n+p=1 and number average molecular weight of ˜200,000 was shown to form a very effective dielectric coating on stainless steel substrate. Those trained in this art recognize that the solution formulation might need to be adjusted for the high molecular weight polymers to account for their higher viscosities to optimize wetting and coating thickness and uniformity. Similarly, the curing conditions might need to be extended to achieve complete curing depending upon the number of reactive functional groups in the polysilsesquioxane.

In one aspect of the present invention, the silsesquioxane polymer comprises a polymethylsilsesquioxane of the formula:
[CH₃SiO_{(3/2)}]ₙ

This starting polymethylsilsesquioxane is preferably prepared in a two-phase system of water and organic solvent consisting of oxygenated organic solvent and optionally up to 50 volume % (based on the oxygenated organic solvent) hydrocarbon solvent by hydrolyzing a methyltrihalosilane MeSiX₃ (Me=methyl and X=halogen atom) and condensing the resulting hydrolysis product.

Preferred methods for synthesizing the polymethylsilsesquioxane resins are exemplified by the following: (1) forming a two-phase system of water (optionally containing the dissolved salt of a weak acid with a buffering capacity or a dissolved water-soluble inorganic base) and oxygenated organic solvent, optionally containing no more than 50 volume % hydrocarbon solvent, adding the below-described (A) or (B) dropwise to this system to hydrolyze the methyltrihalosilane, and effecting condensation of the resulting hydrolysis product, wherein: (A) is a methyltrihalosilane MeSiX₃ (Me=methyl and X=halogen atom) and (B) is the solution afforded by dissolving such a methyltrihalosilane in oxygenated organic solvent optionally containing no more than 50 volume % hydrocarbon solvent; (2) the same method as described under (1), but in this case effecting reaction in the two-phase system from the dropwise addition of the solution described in (B) to only water; (3) the same method as described under (1), but in this case effecting reaction in the two-phase system from the simultaneous dropwise addition of water and the solution described in (B) to an empty reactor. “X,” the halogen in the subject methyltrihalosilane, is preferably bromine or chlorine and more preferably is chlorine. As used herein, the formation of a two-phase system of water and organic solvent refers to a state in which the water and organic solvent are not miscible and hence will not form a homogeneous solution. This includes the maintenance of a layered state by the organic layer and water layer through the use of slow-speed stirring as well as the generation of a suspension by vigorous stirring.

The organic solvent used in the subject preparative methods is an oxygenated organic solvent that can dissolve the methyltrihalosilane and, although possibly evidencing some solubility in water, can nevertheless form a two-phase system with water. The organic solvent can contain up to 50 volume % hydrocarbon solvent.

The use of more than 50 volume % hydrocarbon solvent is impractical because this causes gel production to increase at the expense of the yield of target product. Even an organic solvent with an unlimited solubility in water can be used when such a solvent is not miscible with the aqueous solution of a water-soluble inorganic base or with the aqueous solution of a weak acid salt with a buffering capacity.

The oxygenated organic solvents are exemplified by, but not limited to, ketone solvents such as methyl ethyl ketone, diethyl ketone, methyl isobutyl ketone, acetylacetone, cyclohexanone, and so forth; ether solvents such as diethyl ether, di-n-propyl ether, dioxane, the dimethyl ether of diethylene glycol, tetrahydrofuran, and so forth; ester solvents such as ethyl acetate, butyl acetate, butyl propionate, and so forth; and alcohol solvents such as n-butanol, hexanol, and so forth. The ketone, ether, and ester solvents are particularly preferred among the preceding. The oxygenated organic solvent may also take the form of a mixture of two or more selections from the preceding.

The hydrocarbon solvent is exemplified by, but again not limited to, aromatic hydrocarbon solvents such as benzene, toluene, xylene, and so forth; aliphatic hydrocarbon solvents such as hexane, heptane, and so forth; and halogenated hydrocarbon solvents such as chloroform, trichloroethylene, carbon tetrachloride, and so forth. The quantity of the organic solvent used is not critical, but preferably is in the range from 50 to 2,000 weight parts per 100 weight parts of the methyltrihalosilane. The use of less than 50 weight parts organic solvent per 100 weight parts methyltrihalosilane is inadequate for dissolving the starting polymethylsilsesquioxane product. Depending on the circumstances, resin polymers with high molecular weights are usually obtained. The use of more than 2,000 weight parts organic solvent can lead to slow the hydrolysis and condensation of the methyltrihalosilane. While the quantity of water used is also not critical, the water is preferably used at from 10 to 3,000 weight parts per 100 weight parts methyltrihalosilane.

Hydrolysis and condensation reactions are also possible even with the use of entirely additive-free water as the aqueous phase. This system has the potential to give a polymethylsilsesquioxane product with an elevated molecular weight because the reaction is accelerated by the hydrogen chloride evolved from the chlorosilane. Polymethylsilsesquioxane with a relatively lower molecular weight can therefore be synthesized through the addition of water-soluble inorganic base capable of controlling the acidity or a weak acid salt with a buffering capacity.

Such water-soluble inorganic bases are exemplified by water-soluble alkalis such as the lithium, sodium, potassium, calcium, and magnesium hydroxides. The subject weak acid salt with a buffering capacity is exemplified by, but not limited to, carbonates such as the sodium, potassium, calcium, and magnesium carbonates; bicarbonates such as the sodium and potassium bicarbonates; oxalates such as potassium trihydrogen bis(oxalate); carboxylates such as potassium hydrogen phthalate and sodium acetate; phosphates such as disodium hydrogen phosphate and potassium dihydrogen phosphate; and borates such as sodium tetraborate. These are preferably used at 1.8 gram-equivalents per 1 mole halogen atoms from the trihalosilane molecule. In other words, these are preferably used at up to 1.8 times the quantity that just neutralizes the hydrogen halide that is produced when the halosilane is completely hydrolyzed. The use of larger amounts facilitates the production of insoluble gel. Mixtures of two or more of the water-soluble inorganic bases and mixtures of two or more of the buffering weak acid salts can be used as long as the total is within the above-specified quantity range.

The methyltrihalosilane hydrolysis reaction bath can be stirred slowly at a rate that maintains two layers (aqueous phase and organic solvent) or can be strongly stirred so as to give a suspension. The reaction temperature is suitably in the range from room (20° C.) temperature to 120° C. and is preferably from about 40° C. to 100° C. The starting polymethylsilsesquioxane according to the present invention may contain small amounts of units that originate from impurities that may be present in the precursors, for example, units bearing non-methyl lower alkyl, monofunctional units as represented by R3 SiO 1/2, difunctional units as represented by R 2 SiO2/2, and tetrafunctional units as represented by SiO4/2. The starting polymethylsilsesquioxane under consideration contains OH groups as well as others denoted in the formula above. In addition to halosilanes as raw materials for the preparation of methylsilsesquioxanes and of other alkylsilsesquioxanes; alkoxysilanes can also be used as raw materials. The hydrolysis and condensation of the alkoxysilanes being assisted by catalytic amounts of acids or bases. When silylation of the hydroxyl sites is performed, conventional silylation techniques are utilized. The organic groups of the silyl ‘caps’ maybe reactive or unreactive. Common examples include: substituted and unsubstituted monovalent hydrocarbon groups, for example, alkyl such as methyl, ethyl, and propyl; aryl such as phenyl; and organic groups as afforded by halogen substitution in the preceding.

In another aspect of the present invention, silsesquioxane polymers may be fractionated to give appropriate molecular weight fractions or may be filled with various reinforcing fillers (such as silica, titania, aluminosilicate clays, etc.). In a preferred instance these reinforcing agents consist of colloidal silica particles. The colloidal silica particles may range in size from 5 to 150 nanometers in diameter, with a particularly preferred size of 75 nanometers and 25 nanometers.

It is preferred that the reinforcing fillers are surface treated to increase the compatibility and interfacial adhesion with the siloxane resin matrix. For example, the hydroxyl groups on the surface of the colloidal silica particles may be treated with organylsilyl groups by reacting with appropriate silanes or siloxanes under acidic or basic consitions. Suitable reactive silanes or siloxanes can include finctionalities such as: vinyl, hydride, allyl, aryl or other unsaturated groups. Particularly preferred siloxanes for use as a surface coating include hexamethyldisiloxane and tetramethyldivinyldisiloxane among others.

According to one aspect of the invention, surface coated silica particles may be formed by mixing silica particles with deionized water to form a suspension and then adding concentrated hydrochloric acid, isopropyl alcohol, and a siloxane or mixture of siloxanes. The above mixture is then heated to 70° C. and is allowed to stir for 30 min. As the hydrophilic silica becomes hydrophobic due to the silylation of silica surface silanols, the silica phase separates from the aqueous phase. Once separation occurs, the aqueous layer (isopropyl alcohol, water, excess treating agent and HCl) is decanted. Deionized water is added to the decanted mixture to wash the treated silica. This step may be repeated a second time to insure adequate washing. To the washed silica solution, a solvent is added and the mixture is heated to reflux to azeotrope residual water and water-soluble reagents.

In another aspect of the present invention the dielectric coating comprises a silsesquioxane copolymer comprising units that have the empirical formula [RSi(OH)ₓO_{y})ₙ(Si(OH)_{z}O_{w})ₘ], where x+y=3; z+w=4; and n+m=1 and typically the R group is nonfunctional selected from the group consisting of alkyl and aryl groups. Suitable alkyl groups include methyl, ethyl, isopropyl, n-butyl, and isobutyl groups. Suitable aryl groups include phenyl groups. Typically these silsesquioxane copolymers are prepared via hydrolysis-condensation of tetraalkoxy or tetrahalo silanes and alkylsilanes in oxygenated solvents. Common tetraalkoxysilanes are tetraorthoethylsilicate and tetraorthomethylsilicate. Common tetrahalosilane is tetrachlolosilane, SiCl₄ and common alkylsilanes are methyltrimethoxysilane, phenyltrimethoxysilane, propyltriethoxysilane, propyltnmethoxysilane n-butyltriethoxysilane and others. In addition to the trifunctional silanes difunctional monofunctional and mixtures of therefrom can be used in addition with the tetrafunctional silanes to prepare these prepolymers.

In another aspect of the present invention the dielectric coating comprises a silsesquioxane copolymer comprising units that have the empirical formula Rₐ¹R_{b}²R_{c}³SiO_{(4-a-b-c)/2}, wherein: a is zero or a positive number, b is zero or a positive number, c is zero or a positive number, with the provisos that 0.8≦(a+b+c)≦3.0 and component (A) has an average of at least 2 R¹ groups per molecule, and each R¹ is a functional group independently selected from the group consisting of hydrogen atoms and monovalent hydrocarbon groups having aliphatic unsaturation, and each R² and each R³ are monovalent hydrocarbon groups independently selected from the group consisting of nonfunctional groups and R¹. Preferably, R¹ is an alkenyl group such as vinyl or allyl. Typically, R² and R³ are nonfunctional groups selected from the group consisting of alkyl and aryl groups. Suitable alkyl groups include methyl, ethyl, isopropyl, n-butyl, and isobutyl groups. Suitable aryl groups include phenyl groups. Suitable silsesquioxane copolymers are exemplified by (PhSiO _{3/2})_{0.75} (ViMe₂ SiO_{1/2})_{0.25}, where Ph is a phenyl group, Vi represents a vinyl group, and Me represents a methyl group.

The silsesquioxane copolymer may be cross-linked with a silicon hydride containing hydrocarbon having the general formula Hₐ R_{b}¹ SiR²Si R_{c}¹ H_{d} where R¹ is a monovalent hydrocarbon group and R² is a divalent hydrocarbon group and where a and d≧1, and a+b=c+d=3. The general formula Hₐ R_{b}¹ SiR²Si R_{c}¹ H_{d} although preferred in the present invention is not exclusive of other hydrido silyl compounds that can function as cross-linkers. Specifically a formula such as the above, but where R² is a trivalent hydrocarbon group can also be suitable as cross-linkers. Other options for cross-linkers can be mixtures of hydrido-silyl compounds as well. An example of such a silicon hydride containing hydrocarbon includes p-bis(dimethylsilyl)benzene which is commercially available from Gelest, Inc. of Tullytown, Pa.

A cross-linker may also be a silane or siloxane that contain silicon hydride functionalities that will cross-link with the vinyl group of the silsesquioxane copolymer. Examples of suitable silanes and siloxanes include diphenylsilane and hexamethyltrisiloxane.

In another aspect of the present invention, a polyhdridosilsesquioxane composition may be used as the dielectric coating material. Such compounds are generally prepared from the hydrolysis/condensation of trichlorosilane (HSiCl₃) or trialkoxysilanes in mixed solvent systems and in the presence of surface-active agents. Preferably the polyhdridosilsesquioxane composition is fractionated to give a specific molecular weight range as is described in U.S. Pat. No. 5,063,267 which is hereby incorporated by reference.

In another aspect of the present invention the dielectric coating comprises a phenyl—methyl siloxane resin composition prepared by cohydrolysis of the corresponding chlorosilanes followed by bodying with or without zinc octoate. Appropriate phenyl-methyl siloxane compounds and methods of forming them are disclosed in U.S. Pat. No. 2,830,968 which is hereby incorporated by reference.

The dielectric coatings can be prepared using various common coating processes. These can be batch process or continuous process. A common laboratory batch process is the draw method, using various size laboratory rods to produce coatings of predetermine thickness. A common continuous coating process is the gravure roll method.

### EXAMPLES

The following examples are intended to illustrate the invention to those skilled in the art and should not be interpreted as limiting the scope of the invention as set forth in the appended claims.

### Example 1

In this example the dielectric high temperature coating is based upon the polymethylsilsesquioxane class of materials. These materials are being prepared from the hydrolysis/condensation of methyl trichlorosilane or methyl trialkoxysilanes.

In the 20 wt % MIBK solution of silanol functional polymethylsilsesquioxane, 0.1 wt % tin dioctoate (based on the resin solid content) as a catalyst was added. The solution was coated onto stainless steel substrate (which was washed with acetone and toluene) by using a laboratory coating rod #4 (R.D. Specialties). Coating was cured at 100° C. for 12 hours and 200° C. for 3 h in an air. The coating was characterized by optical microscopy, field emission scanning electron microscopy, atomic force microscopy, profilometry and spectral reflection interferometry. The data showed that the coating was uniform and had very good planarity. The average thickness of the coating was 3.8 micrometers and its average surface roughness on a 5 micrometer continuous and uniform area was 0.9 nanometer. The adhesion with the substrate was very good as shown from the fact the interface remained intact after cryoscopic microtomy. The coated substrate was used to build a photovoltaic cell device based on CIGS deposition technology, with efficiency comparable to that of current standards. The coated substrate is suitable for device fabrication such as photovoltaic cells, which are based on silicon deposition technology or other. It is also suitable for flexible battery device fabrication as well as light emitting devices, which are based on organic light emitting diodes or polycrystalline silicon thin film transistor technology.

### Example 2

In this example the dielectric high temperature coating is also based on the polymethylsilsesquioxane class of materials. The resin differs from the one used in example 1 in that it contains only a predetermined fraction of the total molecular weight distribution of the initial polymer. This fraction was obtained by solvent precipitation with acetonitrile from the toluene solution of the initial bulk polymer.

A 40 wt % solution of polymethylsilsesquioxane was prepared in Dow Corning siloxane solvent OS-30. There was no curing catalyst added in the solution. The solution was coated onto a stainless steel substrate (which was washed with acetone and toluene) using a laboratory coating rod #10 (R.D. Specialties). The coating was cured according to the following curing cycle: 100° C. for 10 min, 200° C. for 1 hour, 300° C. for 30 min. The coated substrate is suitable for device fabrication such as photovoltaic cells, which are based on CIGS deposition technology or silicon deposition technology or other. It is also suitable for flexible battery device fabrication as well as light emitting devices, which are based on organic light emitting diodes or polycrystalline silicon thin film transistor technology.

### Example 3

In this example the dielectric high temperature coating is based on polyhydridosilsesesquioxane class of materials. These materials are prepared from the hydrolysis/condensation of trichlorosilane (HSiCl₃) or trialkoxysilanes in mixed solvent systems and in the presence of surface-active agents followed by solvent fractionation to isolate a particular distribution of molecular weight.

A 20 wt % MIBK solution of polyhydridosilsesquioxane was coated onto stainless steel substrate (which was first washed with acetone and toluene) by using a laboratory coating rod #4 (R.D. Specialties). The coating was cured at 100° C. for 18 hours and 200° C. for 3 h, and then slowly ramped up to 400° C. at a heating rate of ca. 2° C./min and kept at 400° C. for 30 min. (At a separate experiment when larger samples were prepared, the solution concentration was adjusted to 18 wt % and the coating was prepared using a laboratory rod #3. The high temperature step was allowed to extend up to 2 hours). The coating was characterized by optical microscopy, field emission scanning electron. microscopy, atomic force microscopy, and profilometry. The data showed that the coating was uniform and had very good planarity. The average thickness of the coating was approximately 1.2 micrometers and its average surface roughness on a 2-micrometer continuous and uniform area was 0.5 nanometer. The adhesion with the substrate was very good as shown from the fact that the interface remained intact after cryoscopic microtomy. The coated substrate was used to build a photovoltaic cell device based on CIGS deposition technology, with efficiency comparable to current standards. The coated substrate is suitable for device fabrication such as photovoltaic cells, which are based on silicon deposition technology or other. It is also suitable for flexible battery device fabrication as well as light emitting devices, which are based on organic light emitting diodes or polycrystalline silicon thin film transistor technology.

### Example 4

In this example the dielectric high temperature coating is based on a commercial Dow Corning phenyl—methyl siloxane resin composition, DC-805. The resin is prepared by cohydrolysis of the corresponding chlorosilanes followed by bodying with or without zinc octoate.

A 60 wt % xylene solution DC-805 resin in toluene (36 wt. % solid content) containing 0.1 wt % (with respect to the resin solid content) tin dioctoate was coated onto a stainless steel substrate (which was pre-washed with toluene by using a laboratory rod#4 (R.D. Specialties). The coating was cured at 100° C. for 4 h in air, followed by 200° C. for 4 h in air. The coated substrate is suitable for device fabrication such as photovoltaic cells, which are based on CIGS deposition technology or silicon deposition technology or other. It is also suitable for flexible battery device fabrication as well as light emitting devices, which are based on organic light emitting diodes or polycrystalline silicon thin film transistor technology.

### Example 5

In this example the dielectric high temperature coating is based upon the polymethylsilsesquioxane class of materials that also contain fillers such as colloidal silica.

To a 40 wt % MEBK solution of polymethylsilsesquioxane, containing 0.1 wt % tin dioctoate (based on the amount of solid resin), the appropriate amount of a 30 wt % colloidal silica suspension in MEK was added under continuous stirring to produce a mixture consisting of equivalent weights of colloidal silica and polymethylsilsesquioxane. The mixture was coated onto stainless steel substrate (which was washed with acetone and toluene) by using a laboratory coating rod #3 (R.D. Specialties). The coating was cured at 100 ° C. for 1 hour and 200° C. for 6 h in an air. The coating was characterized by optical microscopy, field emission scanning electron microscopy, atomic force microscopy (AFM) and profilometry. The data showed that the coating itself had a relatively fine, uniform texture. Discrete, tightly packed silica particles measured ˜130 nm. The average thickness of the coating was ˜1.7 micrometers and its average surface roughness was 66 nanometers (as measured via profilometry) and 28.9 nanometers via atomic force microscopy (on a 25 micrometer continuous area). [Profilometry measures much larger areas than AFM, and the results could reflect the presence of debris particles]. The adhesion with the substrate was very good as shown from the fact that the interface remained intact after cryoscopic microtomy. The coated substrate is suitable for device fabrication such as photovoltaic cells, which are based on CIGS deposition technology or silicon deposition technology or other. It is also suitable for flexible battery device fabrication as well as light emitting devices, which are based on organic light emitting diodes or polycrystalline silicon thin film transistor technology.

While a preferred embodiment is disclosed, a worker in this art would understand that various modifications would come within the scope of the invention. Thus, the following claims should be studied to determine the true scope and content of this invention.

What is claimed is:

1. A dielectric coating for use on a conductive substrate comprising:
a silicone composition of the formula:
[RSiO_{(4-x)/2}]ₙ
wherein x=1-4 and wherein R comprises a compound selected from the group consisting of: methyl, phenyl, hydrido, hydroxyl, alkoxy groups or a combination of the above or monovalent radicals independently selected from alkyl, aryl , alylamide, arylamide, alkylamino groups and arylamino radicals (when 1<x<4);
said dielectric coating having a network structure.

2. The dielectric coating of claim 1 wherein the silicone composition comprises a silsesquioxane compound of the formula:
[RSiO_{3/2}]ₙ
wherein R comprises a compound selected from the group consisting of: methyl, phenyl, hydrido, hydroxyl, alkoxy or a combination of the above or monovalent radicals independently selected from alkyl, aryl , alylamide, arylamide, alkylamino groups and arylamino radicals (when 1<x<4) (when 1<x<4).

3. The dielectric coating of claim 2 wherein the silsesquioxane compound further includes silanol units of the formula: [Rsi (OH)ₓO_{y} where x+y=3 and which can be siliylated with appropriate organisiloxanes to produce corresponding silylated polysilsesquioxanes.

4. The dielectric coating of claim 1 wherein the silicone composition comprises a polymethyl silsesquioxane of the formula:
[CH₃SiO_{(3/2)}]ₙ.

5. The dielectric coating of claim 1 wherein the silicone composition comprises a silsesquioxane copolymer of the formula:
R¹ₐR²_{b}R³_{c}SiO_{(4-a-b-c)/2},
wherein: a is zero or a positive number, b is zero or a positive number, c is zero or a positive number, with the provisos that 0.8≦(a+b+c)≦3.0 and wherein the copolymer has an average of at least 2 R¹ groups per molecule, and each R¹ is a functional group independently selected from the group consisting of hydrogen atoms and monovalent hydrocarbon groups having aliphatic unsaturation, and each R² and each R³ are monovalent hydrocarbon groups independently selected from the group consisting of nonfunctional groups and R¹.

6. The dielectric coating of claim 5 wherein R¹ is an alkenyl group and R² and R³ are nonfunctional groups selected from the group consisting of alkyl and aryl groups.

7. The dielectric coating of claim 6 wherein R¹ is selected from the group consisting of vinyl and allyl groups.

8. The dielectric coating of claim 6 wherein R² and R³ are selected from the group consisting of methyl, ethyl, isopropyl, n-butyl, and isobutyl groups.

9. The dielectric coating of claim 1 wherein the silicone composition comprises a phenyl-methyl siloxane compound of the formula:
[(MeSiO_{3/2})_{0.25}(PhSiO_{3/2})_{0.15}(Ph₂SiO)_{0.50}

10. A substrate structure comprising:
a conductive material;
a dielectric coating disposed on a surface of the conductive material
said dielectric coating comprising a slicone composition of the formula:
[RSiO_{(4-x)/2}]ₙ
wherein x=1-4 and wherein R comprises a compound selected from the group consisting of: methyl, phenyl, hydrido, hydroxyl, alkoxy groups or a combination of the above or monovalent radicals independently selected from alkyl, aryl , alylamide, arylamide, alkylamino groups and arylamino radicals (when 1<x<4); said dielectric coating having a network structure.

11. The substrate of claim 10 wherein the silicone composition comprises a silsesquioxane compound of the formula:
[RSiO_{3/2}]ₙ
wherein R comprises a compound selected from the group consisting of: methyl, phenyl, hydrido, hydroxyl, alkoxy or a combination of the above or monovalent radicals independently selected from alkyl, aryl , alylamide, arylamide, alkylamino groups and arylamino radicals (when 1<x<4) (when 1<x<4).

12. The substrate of claim 11 wherein the silsesquioxane compound further includes silanol units of the formula: [Rsi (OH)ₓO_{y} where x+y=3 and which can be siliylated with appropriate organisiloxanes to produce corresponding silylated polysilsesquioxanes.

13. The substrate of claim 10 wherein the silicone composition comprises a polymethyl silsesquioxane of the formula:
[CH₃SiO_{(3/2)}]ₙ.

14. The substrate of claim 10 wherein the silicone composition comprises a silsesquioxane copolymer of the formula:
R¹ₐR²_{b}R³_{c}SiO_{(4-a-b-c)/2},
wherein: a is zero or a positive number, b is zero or a positive number, c is zero or a positive number, with the provisos that 0.8≦(a+b+c)≦3.0 and wherein the copolymer has an average of at least 2 R¹ groups per molecule, and each R¹ is a functional group independently selected from the group consisting of hydrogen atoms and monovalent hydrocarbon groups having aliphatic unsaturation, and each R² and each R³ are monovalent hydrocarbon groups independently selected from the group consisting of nonfunctional groups and R¹.

15. The substrate of claim 14 wherein R¹ is an alkenyl group and R² and R³ are nonfunctional groups selected from the group consisting of alkyl and aryl groups.

16. The substrate of claim 15 wherein R¹ is selected from the group consisting of vinyl and allyl groups.

17. The substrate of claim 15 wherein R² and R³ are selected from the group consisting of methyl, ethyl, isopropyl, n-butyl, and isobutyl groups.

18. The substrate of claim 1 wherein the silicone composition comprises a phenyl-methyl siloxane compound of the formula:
[(MeSiO_{3/2})_{0.25}(PhSiO_{3/2})_{0.15}(Ph₂SiO)_{0.50}.
